(19) United States
(12) Patent Application Publication
(10) Pub. No.: US 2016/0262337 A1
(43) Pub. Date: Sep. 15, 2016

(54) AUTOMATED MILKING STALL

(71) Applicant: R. J. FULLWOOD & BLAND LTD, Ellesmere, Shropshire (GB)

(72) Inventor: John Richard LANCASTER, Shrewsbury (GB)

(73) Assignee: R. J. FULLWOOD & BLAND LTD, Ellesmere, Shropshire (GB)

(21) Appl. No.: 15/031,635

(22) PCT Filed: Oct. 20, 2014
(86) PCT No.: PCT/GB2014/000426

§ 371 Date: Apr. 22, 2016

(30) Foreign Application Priority Data
Oct. 22, 2013 (GB) 1318641.6

(51) Int. Cl. A01J 5/013; H04N 5/33; A01J 5/007; A01K 29/00; A01K 1/12; A01K 15/04

(52) U.S. Cl. CPC A01J 5/0131; A01K 1/12; A01K 15/04; A01J 5/007; A01J 5/0135; A01J 5/0138; A01K 29/005; H04N 5/33

(57) ABSTRACT

A milking stall includes a base structure supporting a pen within which an animal undergoing milking may be enclosed, the pen including at least one entrance gate and first and second exit gates, each gate being movable between an open position in which an animal may pass through the gate and a closed position in which an animal is unable to do so.

### BACKGROUND TO THE INVENTION

1. Field of the Invention

The present invention relates to an automated milking stall for animals such as cattle, goats and the like.

2. Description of Related Art

Such milking stalls or parlours are known per se and comprise an entry gate via which the animal will enter the parlour and which is closed during milking to retain the animal in the parlour; an exit gate which opens automatically when milking has ended and a robot arm which carries, at its distal end, teat cups. The robot arm is automatically movable into (and, when milking is finished, out of) a position in which the teat cups may engage with the teats of the animal.

Automated milking parlours are also known to comprise or be linked to various analysis equipment whose purpose is to record and analyse parameters associated with both the milking process and the milk yielded by that process. The purposes of such analyses include the obtaining of data on the individual animal's milk yield as well as to establish whether the animal is, at the time of milking, displaying indications of illness requiring intervention and/or withhold of its milk from human consumption. The process of automation in animal milking is known to use data obtained during milking which indicates illness then to segregate the unwell animal. Typically, this will involve herding the animal, once it has exited the milking parlour, into a separate compound using an automated gate. Alternatively, the animal may be segregated for routine attention on the instruction of the operator.

### SUMMARY OF THE INVENTION

The present invention provides a milking stall comprising a base structure to which an enclosing frame is mounted; the enclosing frame including at least one entrance gate and first and second exit gates each of the gates being movable between an open position in which an animal may pass though the gate and a closed position in which an animal is unable to do so. In a preferred embodiment, the stall comprises a control system which is operable to actuate the first exit gate when a signal is received indicating that the animal is unwell or otherwise required for individual attention and to actuate the second exit gate when a signal is received indicating there is no requirement to segregate.

### BRIEF DESCRIPTION OF DRAWINGS

Embodiments of the invention will now be described, by way of example, and with reference to the accompanying drawings, in which:

FIG. 1 is a perspective view of an embodiment of milking stall according to the present invention;

FIG. 2 is a plan view of the embodiment of FIG. 1;

FIG. 3 is a plan view of a detail of FIGS. 1 and 2;

FIGS. 4 to 7 are plan views of different modes of operation of the embodiment of milking stall according to the present invention; and

FIG. 8 is a schematic illustration of control of the exits to the embodiment of milking stall in FIGS. 1 to 7.

### DESCRIPTION OF PREFERRED EMBODIMENTS

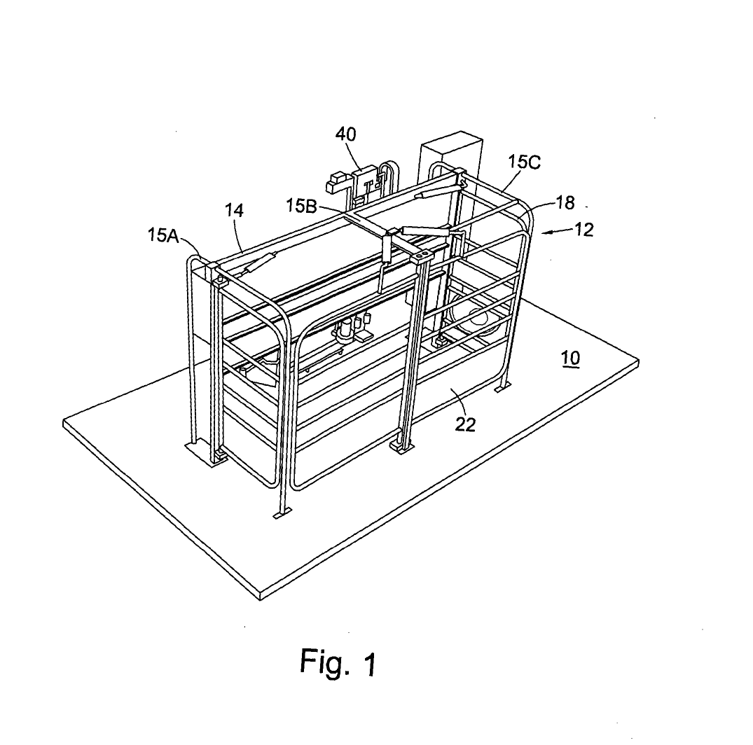

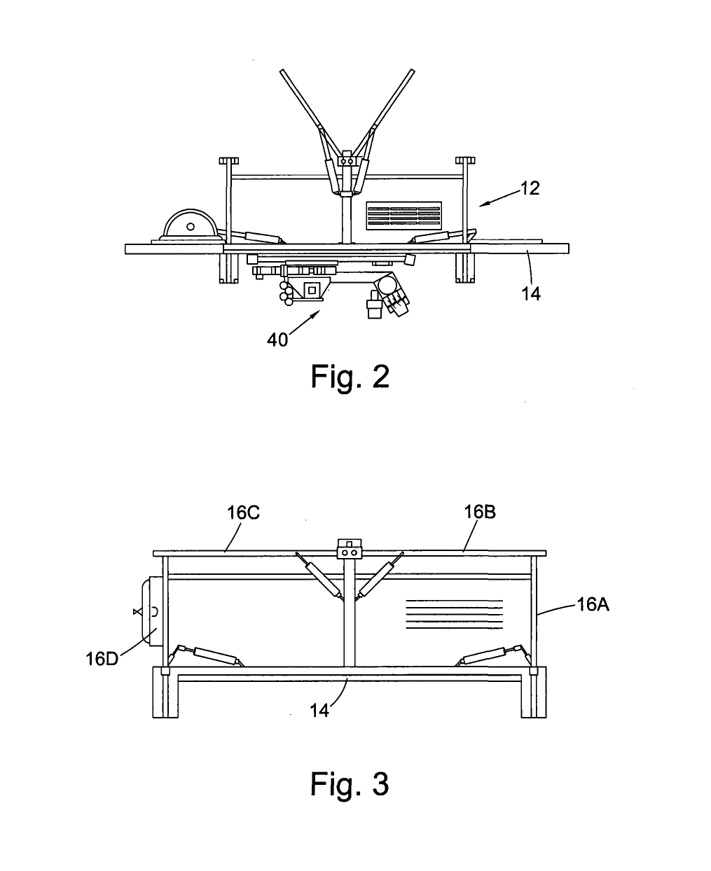

Referring now to FIGS. 1 to 3, an automated milking stall for comprises a planar base 10 and, mounted upon the base, a pen 12. In the present embodiment the stall is designed for milking cattle, though this is not essential. The pen 12 is rectangular in plan view and comprises a wall 14 which forms one of the longer sides of the enclosure. The wall 14 extends from the upper level of the enclosure to about halfway down, thereby leaving a substantial gap at the bottom. The gap enables a robotically-controlled arm 40 to swing under the wall 14 and engage with a cow's udder for automated milking as will be described subsequently.

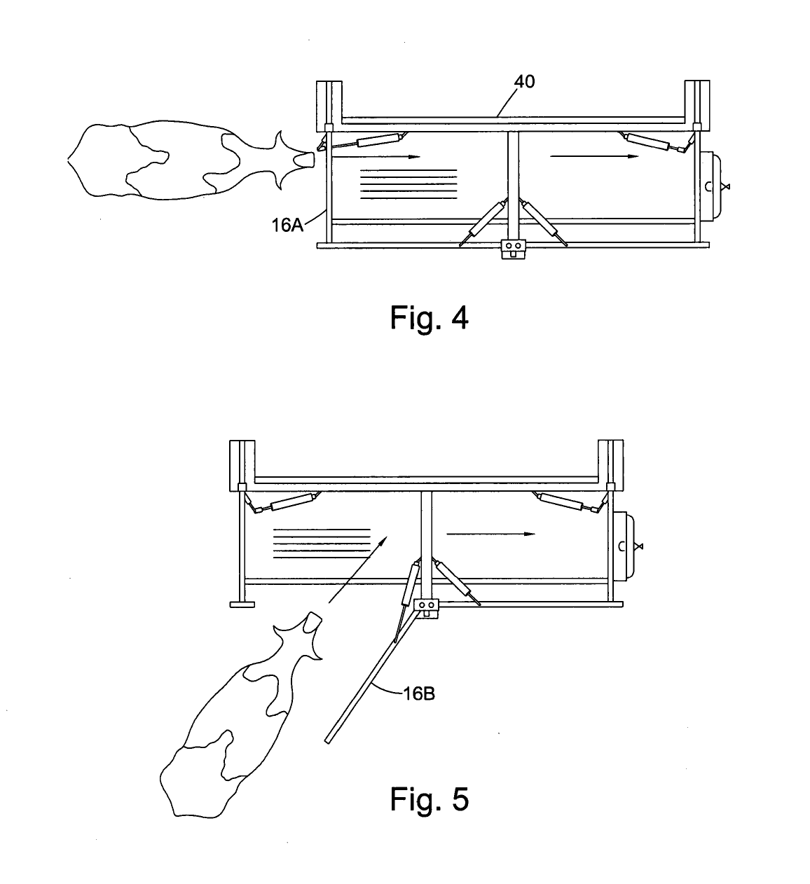

The remaining sides of the pen 12 are provided by a series of gate sections 16A, B, C D (shown most readily in FIG. 3). Each gate section 16 is mounted to a rectangular frame 15A,B,C situated at the ends and the middle of the pen 12. Each gate section 16 comprises a substantially rectangular frame 18 made of tubular spars, typically of galvanised steel though any suitable material may be used. A series transverse struts 20, also made of tubular galvanised steel extend across each frame 18, with the lowermost strut 18 of each gate section 16 and the adjacent parts of the frame 18 each supporting a panel 22. The panels 22 extend transversely around the lowermost part of the three sides of the pen 12 enclosed by the gate sections 16 and serve to avoid or minimise damage to an animal's lower leg in the event that it starts to kick while in the enclosure.

The size of the pen is chosen so that, when an animal is enclosed within the pen 12 its movement is significantly restricted and, as a consequence of which, its udder will be known to be located within a very small area. Once enclosed, this enables a robotic arm, mounted to the remote side of the wall 14 (FIG. 1) to articulate under the wall 14 and to engage with the teats of the cow's udder. Once engaged, milk is extracted from the teats via milk cups (not shown) on the robotic arm into a milk receptacle (not shown) and mounted to the far side of the wall 14. Typically, milk either within the receptacle or which is being transmitted to it will be analysed physically and/or chemically for one or more ‘marker’ measurements which indicate animal illness. In the event that illness is indicated, it will be desirable to segregate the animal from the remainder of the herd both to prevent any possible spread of illness and to ensure the animal may receive appropriate treatment.

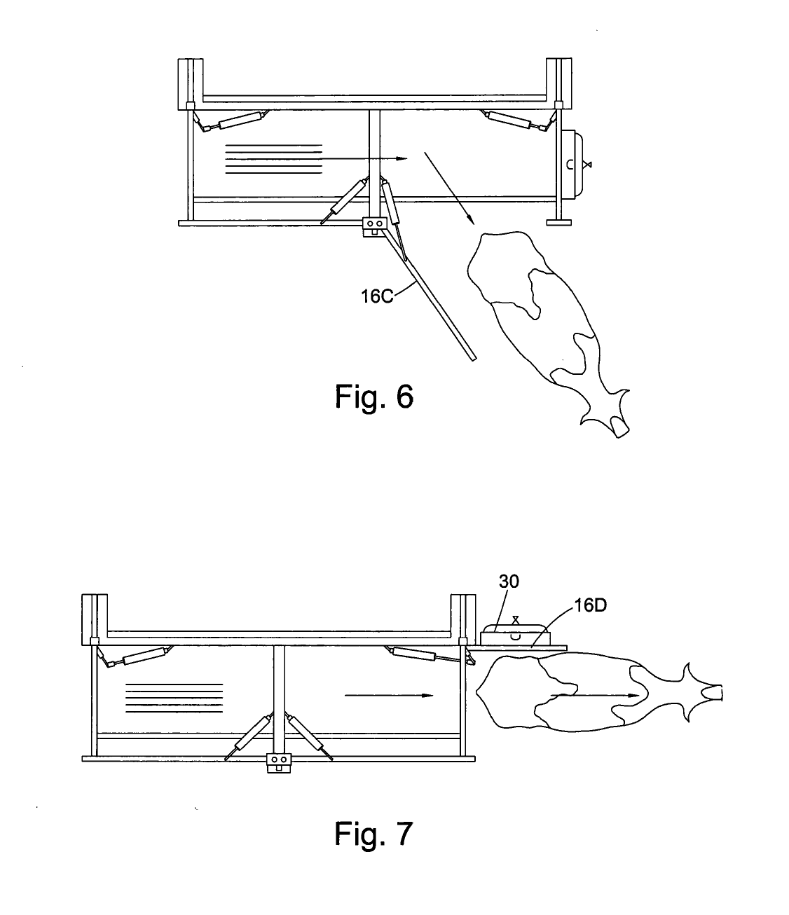

Referring now additionally to FIGS. 4 and 5, in a preferred embodiment two entry gates, 16A, B are pivotally mounted to a end frame 15A for a hinged motion relative to the base 10 thereby providing two alternative entry locations into the milking stall. Thus, gate section 16A is pivotally mounted to a vertical strut 22 forming part of frame 15A in a manner permitting hinged opening of the gate section 16A to allow a cow ‘straight entry’ into the stall, as shown in FIG. 4. Similarly, gate section 16B is pivotally mounted to the centre frame 15B for hinged opening which therefore permits entry into the stall of cattle from a different direction. The stall likewise comprises two exit gates. Thus, gate section 16C is pivotally mounted for hinged opening from middle frame 15B, while gate section 16D is pivotally mounted for hinged opening from end frame 15C. Thus, by means of two differing entry gates, it is possible to select cattle for milking from one of two different animal compounds, for example, and to direct them to one of two different exit compounds. Thus, FIG. 4 illustrates entry via gate 16A which may open onto a first compound; while FIG. 5, illustrating entry via gate 16B, may open onto a second, distinct compound.

Referring additionally to FIGS. 6 and 7, equally, exit may be via gate 16C as illustrated in FIG. 6; or via gate 16D as illustrated in FIG. 7. If, therefore, it transpires that a cow is diagnosed from the analysis of its milk as showing indications of illness and/or is required for routine operator attention, it can be forced to exit the stall by (say) the gate 16C which opens onto a compound that is entirely separate to the compound onto which ordinary exit gate 16D opens and therefore provides instant and complete segregation of the animal from the moment at which the first indication of the animal's potentially poor health has been detected. Notably, and as illustrated in FIGS. 3 to 7, a feed container 30 is preferably located on an exit gate 16D (though the container may equally be located elsewhere in a location accessible by the animal when located inside the pen)

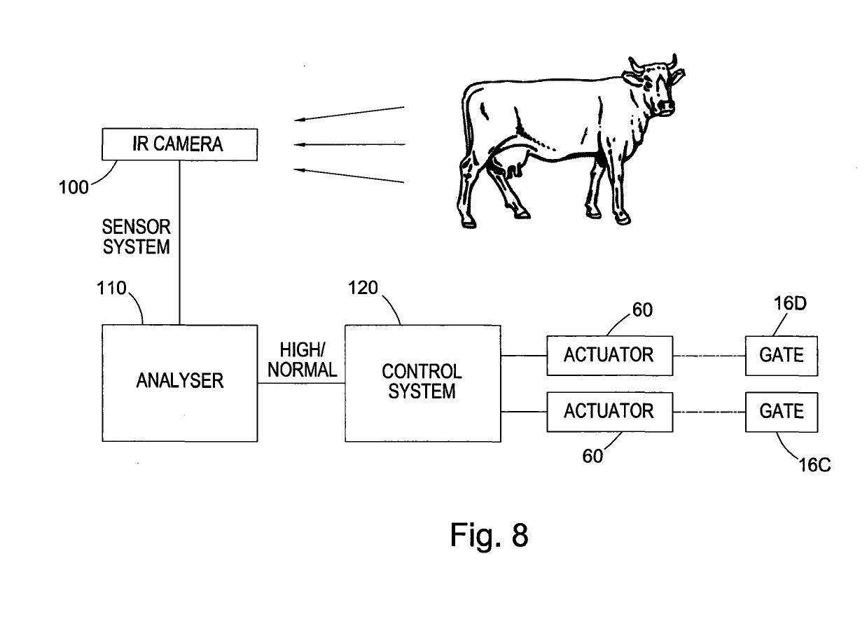

Referring now to FIG. 8, control of the gates may, in one preferred embodiment, be based upon the health of the animal. Thus, according to one embodiment, an infra red camera 100 is located on a frame 15A, B, C and scans the animal whilst it is milking. An IR scan analyser 110 establishes whether the temperature of the animal is within a range which would indicate normal health, or whether the animal's temperature indicates ill-health. The output signal of the scan analyser 110 is sent to the control system 120. If the scan analyser output signals normal health, the control system operates the hydraulic actuator 60 associated with gate 16D and the animal exits the pen of the stall to join the other animals. If, however, the scan analyser output signals ill health, the control system operates the motor on gate 16C and the animal exits to an entirely separate compound without ever, at any subsequent point, coming into contact with any of the other animals. For ease of illustration only a single sensor, here an IR sensor to indicate body temperature, has been shown. It is equally possible to employ a plurality of such sensors; further it is possible to employ sensors of other parameters which indicate animal wellbeing, such as animal contours for body condition scoring and the like. Further, where ill health is to be used as a basis upon which to control the gate operation, it is not essential to use IR-generated animal heat data; alternative data may be used, such as analysis of the milk temperature and/or composition, for example.

Further, the control system may equally operate upon bases other than animal health. Thus, the control system could be pre-programmed with the identities of specific animals which it is desire to segregate for other reasons and, when he RFID of the or each such animal is detected when milking and transmitted to the control system, the control system may operate to divert the animal out of the appropriate exit gate.

In this way the milking stall can be used additionally as an instant filtering mechanism for animal traffic.

1. A milking stall comprising a base structure supporting a pen within which an animal undergoing milking may be enclosed, the pen comprising at least one entrance gate and first and second exit gates, each gate being movable between an open position in which an animal may pass though the gate and a closed position in which an animal is unable to do so.

2. A milking stall according to claim 1 wherein the first and second exit gates enable exit from the pen at respectively different locations.

3. A milking stall according to claim 1 further comprising a control system for operating the exit gates in dependence upon one or more predetermined signals.

4. A milking stall according to claim 3 further comprising at least one analysis device for analysing the condition of the animal during milking and generating a signal accordingly.

5. A milking stall according to claim 4 wherein the signal is indicative of whether the animal is in good health.

6. A milking stall according to claim 5 wherein the control system operates the first exit gate to allow the animal to exit when the animal is in good health and the second exit gate when the animal is in poor health.

7. A milking stall according to claim 1 wherein one wall of the pen supports an articulating robot arm on which a milking device is carried and which is automatically controllable to articulate into the pen for the purpose of milking an animal and to articulate out of the pen when milking has finished.

8. A milking stall according to claim 7 wherein the articulating robot arm is adapted to articulate, starting from a position outside of the pen, under the wall into the pen to adopt a milking position.

9. A milking stall according to claim 1 further comprising a second entrance gate.

10. A milking stall according to claim 1 further comprising a control system, operable to open an entrance gate and an exit gate, wherein the control system is adapted to select an exit gate for opening based upon a value of one or more parameters indicating animal health.
